(19) United States
(12) Patent Application Publication
(10) Pub. No.: US 2015/0331085 A1
(43) Pub. Date: Nov. 19, 2015

(54) DESTINATION PREDICTION APPARATUS AND METHOD

(71) Applicant: SAMSUNG ELECTRONICS CO., LTD., Suwon-si (KR)

(72) Inventors: Min Young MUN, Seoul (KR); Sang Do PARK, Seoul (KR); Jae Mo SUNG, Hwaseong-si (KR)

(73) Assignee: SAMSUNG ELECTRONICS CO., LTD., Suwon-si (KR)

(21) Appl. No.: 14/714,967

(22) Filed: May 18, 2015

(30) Foreign Application Priority Data
May 16, 2014 (KR) 10-2014-0059014

(51) Int. Cl. G01S 5/02; H04W 4/02

(52) U.S. Cl. CPC G01S 5/0294; H04W 4/025

(57) ABSTRACT

Disclosed is a destination prediction apparatus and destination prediction method. The destination prediction apparatus includes a significant location identifier configured to identify a significant location based on tracking data of a user, a semantic place classifier configured to generate semantic place tracking data by classifying the identified significant location as a semantic place based on semantics, a significant location profiler configured to profile visit data of significant locations of each of the semantic places to generate a significant location profile, and a predictor configured to predict a destination of the user based on the generated semantic place tracking data, the generated significant location profile, and a mobility profile of user groups clustered according to mobility patterns.

### CROSS-REFERENCE TO RELATED APPLICATION(S)

This application claims priority under 35 USC 119(a) from Korean Patent Application No. 10-2014-0059014, filed on May 16, 2014, in the Korean Intellectual Property Office, the entire disclosure of which is incorporated by reference for all purposes.

### BACKGROUND

1. Field

The following description relates to a destination prediction apparatus and method.

2. Description of Related Art

Various services, such as calls, music, movies, Internet surfing, games, photographs, and the like may be provided with mobile devices. Using a Global Positioning System (GPS) chip embedded in mobile devices, a service based on location of a mobile device may be provided. Research is actively being conducted to provide various other services by combining mobile devices with location-based services using GPS information.

In most destination prediction algorithms, destinations may be predicted based on a previous location tracking history, but these algorithms create a long down time when users use services.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a destination prediction apparatus including a significant location identifier configured to identify a significant location based on tracking data of a user, a semantic place classifier configured to generate semantic place tracking data by classifying the identified significant location as a semantic place based on semantics, a significant location profiler configured to profile visit data of significant locations of each of the semantic places to generate a significant location profile, and a predictor configured to predict a destination of the user based on the generated semantic place tracking data, the generated significant location profile, and a mobility profile of user groups clustered according to mobility patterns.

The significant location may include at least one of a location where the user stays for more than a time period, a location where the user visits for more than a number of times, a location where the user visits during a time cycle, or a location that the user visits at a particular time.

The mobility profile of user groups clustered according to the mobility patterns may be pre-defined in a server.

The predictor may include a significant mobility pattern determiner configured to determine a significant mobility pattern of the user based on the generated semantic place tracking data, a user group retriever configured to retrieve a user group having a mobility pattern similar to the determined significant mobility pattern, a destination-semantic place predictor configured to predict a destination-semantic place based on the mobility pattern of the retrieved user group, and a destination location predictor configured to extract at least one destination location that corresponds to the predicted destination-semantic place and the generated significant location profile.

In response to the predicted destination-semantic place not being profiled upon reference to the generated significant location profile, the destination location predictor may be further configured to predict a destination location of the user using other users' significant location profile information that is similar to the profile of the user.

The predictor may be further configured to predict a destination based on the generated semantic place tracking data, the generated significant location profile, the mobility profile of user groups clustered according to mobility patterns, and a mobility profile of user groups clustered according to user characteristics.

The mobility profile of user groups clustered according to mobility patterns and the mobility profile of user groups clustered according to user characteristics may be pre-defined in a server.

The predictor may include a significant mobility pattern determiner configured to determine a significant mobility pattern of the user based on the generated semantic place tracking data, a user group retriever configured to retrieve a first user group having a mobility pattern similar to the determined significant mobility pattern by reference to the mobility profile of the user groups clustered according to the mobility patterns, and to retrieve a second user group having characteristics similar to characteristics of the user by reference to the mobility profile of the user groups clustered according to user characteristics, a destination-semantic place predictor configured to predict at least one destination-semantic place based on the mobility patterns of the first user group and the mobility patterns of the second user group, and a destination location predictor configured to extract at least one destination location that corresponds to the at least one predicted destination and the generated significant location profile.

In response to the at least one predicted destination-semantic place not being among the significant location profile, the destination location predictor may be further configured to predict a destination location of the user using other users' significant location profile information that is similar to the profile of the user.

The visit data may include at least one of arrival time, departure time, a number of visits, a duration of visits, or a time of visit.

The server may be external.

In another general aspect, there is provided a destination prediction method including recognizing a significant location based on tracking data of a user, generating semantic place tracking data based on classifying the significant location as a semantic place based on semantics, and predicting a destination of the user based on the generated semantic place tracking data, a pre-defined significant location profile of the user, and a mobility profile of user groups clustered according to mobility patterns.

The recognizing of the significant location may include recognizing at least one of a location where the user stays for more than a time period, a location where the user visits for more than a number of times, a location where the user visits during a time cycle, or a location that the user visits at a particular time as the significant location.

The predicting of the destination of the user may include determining a significant mobility pattern of the user based on the generated semantic place tracking data, retrieving a user group having a mobility pattern that is similar to the determined significant mobility pattern, predicting a destination-semantic place based on the mobility pattern of the retrieved user group, and extracting at least one destination location that corresponds to the predicted destination-semantic place and the pre-defined significant location profile.

The method may include predicting a destination location of the user using other users' significant location profile information that is similar to the profile of the user, in response to the predicted destination-semantic place not being profiled upon reference to the significant location profile.

The predicting of the destination of the user may include predicting the destination based on the generated semantic place tracking data, the significant location profile, the mobility profile of user groups clustered according to mobility patterns, and a mobility profile of user groups clustered according to user characteristics.

The predicting of the destination of the user may include determining a significant mobility pattern of the user based on the generated semantic place tracking data, retrieving a first user group having a mobility pattern similar to the determined significant mobility pattern by reference to the mobility profile of the user groups clustered according to the mobility patterns, and retrieving a second user group having characteristics similar to characteristics of the user by reference to the mobility profile of the user groups clustered according to the user characteristics, predicting at least one destination-semantic place based on the mobility patterns of the first user group and the mobility patterns of the second user group, and extracting at least one destination location that corresponds to the at least one predicted destination-semantic place and the pre-defined significant location profile.

In response to the at least one predicted destination-semantic place not being among the pre-defined significant location profile, the method may include predicting a destination location of the user by using other users' significant location profile information that is similar to the profile of the user.

In another general aspect, there is provided a destination prediction method including identifying a significant location based on tracking data of a user, generating semantic place tracking data based on classifying the significant location, building a significant location profile based on the identified significant location, determining a significant mobility pattern of the user based on the semantic place tracking data, and predicting a destination of the user based on the significant mobility pattern of the user and the significant location profile.

The predicting of the destination of the user may include retrieving, at the server, a user group having a mobility pattern similar to the significant mobility pattern, predicting a destination-semantic place based on the mobility pattern of the retrieved user group, and extracting at least one destination location that corresponds to the predicted destination-semantic place and the significant location profile.

The predicting of the destination of the user may include retrieving, at the server, a first user group having a mobility pattern similar to the significant mobility pattern by reference to the mobility profile of the user groups clustered according to the mobility patterns, and retrieving a second user group having characteristics similar to characteristics of the user by reference to the mobility profile of the user groups clustered according to the user characteristics, predicting a destination-semantic place based on the mobility patterns of the first user group and the mobility patterns of the second user group, and extracting at least one destination location that corresponds to the predicted destination-semantic place and the significant location profile.

When there is no profiled destination-semantic place among the at least one predicted destination-semantic place upon reference to the significant location profile, the destination prediction method may further include predicting a destination location of the user by using other users' significant location profile information that is similar to the profile of the user.

Other features and aspects will be apparent from the following detailed description, the drawings, and the claims.

### BRIEF DESCRIPTION OF THE DRAWINGS

FIG. 1 is a diagram illustrating an example of a destination prediction apparatus.

FIG. 2 is a diagram illustrating an example of a predictor 140.

FIG. 3 is a diagram illustrating another example of a destination prediction apparatus.

FIG. 4 is a diagram illustrating an example of a predictor 340.

FIG. 5 is a diagram illustrating yet another example of a destination prediction apparatus.

FIG. 6 is a diagram illustrating an example of a destination prediction method.

FIG. 7 is a diagram illustrating another example of a destination prediction method.

FIG. 8 is a diagram illustrating yet another example of a destination prediction method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses, and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

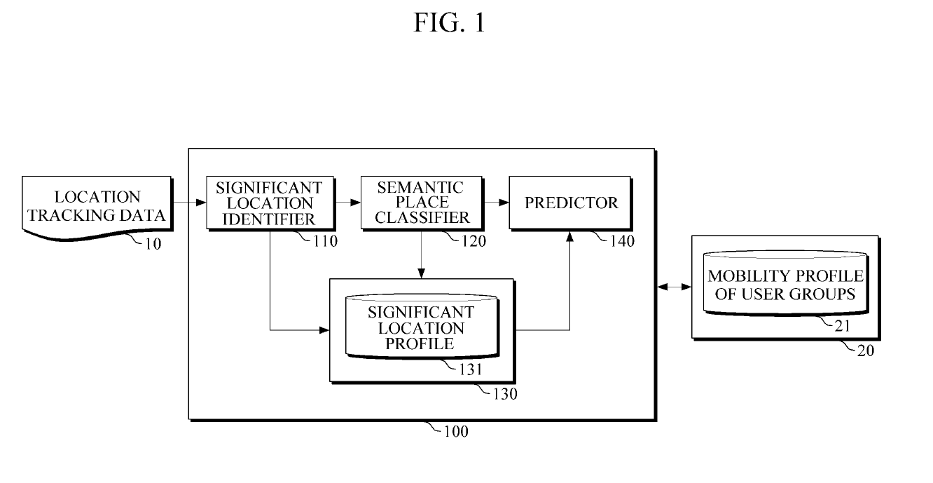

FIG. 1 is a diagram illustrating an example of a destination prediction apparatus. Referring to FIG. 1, the destination prediction apparatus 100 includes a significant location identifier 110, a semantic place classifier 120, a user profiler 130, and a predictor 140.

The significant location identifier 110 may identify significant locations based on location tracking data 10 of a user. The location tracking data 10 may be location data of any type regardless of granularity, such as, for example, GPS data, location data based on Wi-Fi access points, location data based on cell ID such as a base station ID.

In an example shown in FIG. 1, the significant location identifier 110 may identify a significant location based on the location tracking data of a user. Based on the location tracking data, the significant location may be identified as a location, such as, for example, a location where a user stays for more than a time period, a location where a user visits for more than a number of times, a location where a user visits at a specific time cycle, and a location where a user visits at a specific time.

The significant location may have different granularity levels depending on the types of location tracking data, such as, for example, GPS data, location data based on Wi-Fi access points, location data based on cell ID such as a base station ID.

The semantic place classifier 120 may generate semantic place tracking data that corresponds to the location tracking data 10 by identifying semantics of significant locations based on visit data of significant locations identified by the significant location identifier 110 and by classifying identified significant locations as at least one semantic place. The visit data may include data such as, for example, arrival/departure time, a number of visits, the duration of visits, and the time of visits.

A semantic place may be defined as a group of locations with similar semantics and may be labeled as home, company, park, and with other semantic labels by a user.

Based on the classification by the semantic place classifier 120, the significant location profiler 130 may profile visit data, such as, for example, arrival/departure time, a number of visits, the duration of visits, and the time of visits of significant locations for each semantic place to generate a significant location profile 131.

The predictor 140 may predict a destination based on semantic place tracking data, the significant location profile 131, and a mobility profile 21 of user groups clustered according to mobility patterns.

The mobility profile 21 of a user group may be pre-stored in a server. The server may be hardware, software, or some combination of hardware and software. The server may be located at the destination prediction apparatus or may be located external to the destination prediction apparatus. In an example, the server may be a dedicated server, meaning that it performs no other tasks besides its server tasks. In another example, the server may be executed as one of several program on a processor or a computer. The server 20 may group a plurality of users into a plurality of user groups according to mobility patterns and may perform mobility profiling of each user group to generate the mobility profile 21 of user groups.

In an example, the predictor 140 may extract a significant mobility pattern of a user from the semantic place tracking data generated by the semantic place classifier 120 and retrieve, by reference to the mobility profile 21 of the user group, a user group with a mobility pattern that is similar to the significant mobility pattern of a user. The predictor 140 may predict a destination-semantic place of a user based on the mobility pattern of the retrieved user group. By reference the significant location profile 131, the predictor 140 may predict a destination location by detecting at least one significant location that corresponds to the predicted destination-semantic place.

If the predicted destination-semantic place is not profiled upon reference to the significant location profile 131, the predictor 140 may predict a destination location of a user by using other users' significant location profile information similar to a profile of the user.

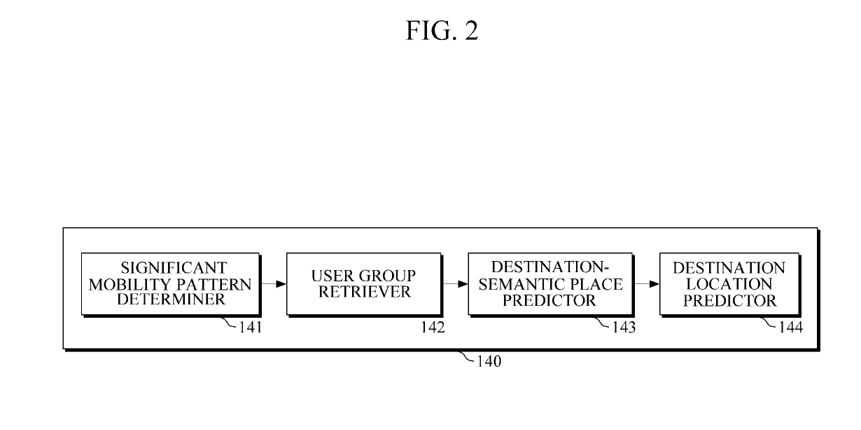

The predictor 140 will be further with reference to FIG. 2.

FIG. 2 is a diagram illustrating an example of a predictor 140. Referring to FIG. 2, the predictor 140 includes a significant mobility pattern determiner 131, a user group retriever 142, a destination-semantic place predictor 143, and a destination location predictor 144.

The significant mobility pattern determiner 141 may determine a significant mobility pattern of a user based on semantic place tracking data generated by the semantic place classifier 120. For example, the significant mobility pattern determiner 141 may determine a significant mobility pattern of a user using methods such as, for example, a frequent item set detection algorithm, a Linear Discriminant Analysis (LDA) algorithm, and a Principal Component Analysis (PCA) algorithm. The method for determining a significant mobility pattern of a user algorithm is not limited to the examples mentioned above, and any method for determining a dominant or significant mobility pattern may also be used without departing from the spirit and scope of the illustrative examples described.

Using the user group mobility profile 21, the user group retriever 142 may retrieve a user group with a mobility pattern that is similar to the significant mobility pattern of a user determined by the significant mobility pattern determiner 141.

For example, the user group retriever 142 may calculate similarities between the significant mobility pattern of a user and a representative mobility profile of each user group to retrieve a user group with the highest similarity. The mobility profile may be represented by a vector or by an n-dimensional matrix. Based on the mobility profile, the user group retriever 142 may calculate similarities using various distance measurement methods.

The destination-semantic place predictor 143 may predict a destination-semantic place based on a representative mobility pattern of each user group retrieved by the user group retriever 142.

The destination location predictor 144 may predict a destination location of a user by referring to the significant location profile 131 generated by the significant location profiler 130 and by detecting at least one destination location corresponding to the destination-semantic place predicted by the destination-semantic place predictor 143.

If the destination-semantic place predicted by the destination-semantic place predictor 143 is not profiled upon reference to the significant location profile 131, the destination location predictor 144 may predict a user's destination location by using other users' significant location profile information similar to the profile of the user.

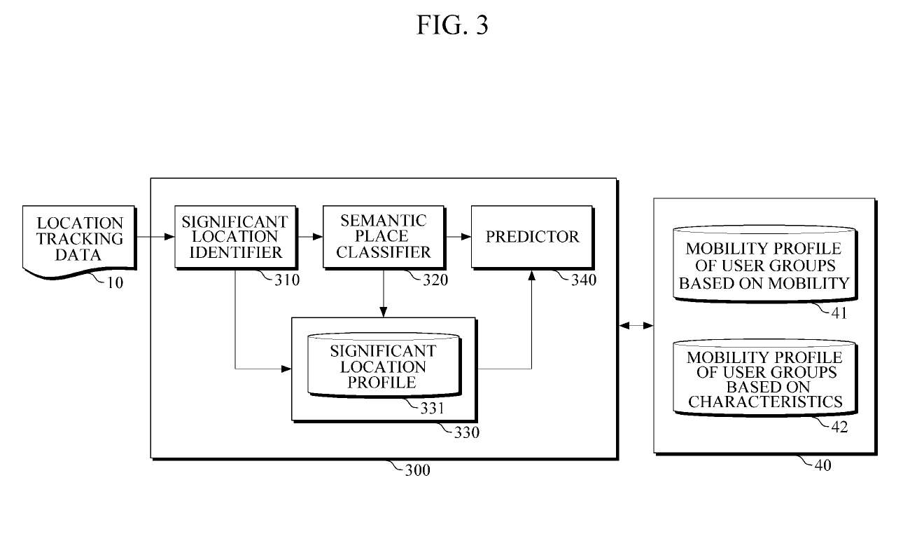

FIG. 3 is a diagram illustrating another example of a destination prediction apparatus.

Referring to FIG. 3, the destination prediction apparatus 300 includes a significant location identifier 310, a semantic place classifier 320, a user profiler 330, and a predictor 340. The significant location identifier 310, the semantic place classifier 320, and the user profiler 330 are identical in function to the significant location identifier 110, the semantic place classifier 120, and the user profiler 130 of the destination prediction apparatus 100, respectively. The above description of the significant location identifier 110, the semantic place classifier 120, and the user profiler 130 of the destination prediction apparatus 100, is also applicable to the destination prediction apparatus 300, and is incorporated herein by reference. Thus, the above description may not be repeated here.

The predictor 340 may predict a destination based on semantic place tracking data generated by the semantic place classifier 320, a significant location profile 331 generated by the significant location profiler 330, and a mobility profile 41 of user groups clustered according to mobility patterns (hereinafter referred to as a mobility profile of user groups based on mobility) and a mobility profile 42 of user groups clustered according to user characteristics (hereinafter referred to as a mobility profile of a user group based on characteristics).

The mobility profile 41 of user groups based on mobility and the mobility profile 42 of user groups based on characteristics may be pre-stored in a server 40. The server 40 may generate the mobility profile 41 of user groups based on mobility by grouping a plurality of users into a plurality of user groups according to mobility patterns and by performing mobility profiling of each user group. Further, the server 40 may generate the mobility profile 42 of user groups based on characteristics by grouping a plurality of users into a plurality of user groups based on user characteristics and by performing mobility profiling of each user group, in which the user characteristics may include biography information, such as, for example, age, gender, ethnicity, and occupation of users.

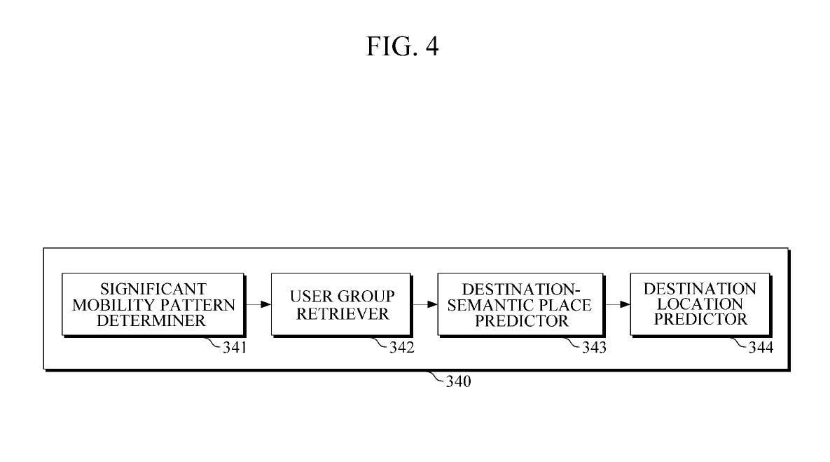

In an example, the predictor 340 may extract a significant mobility pattern of a user from the semantic place tracking data generated by the semantic place classifier 320. The predictor 340 may retrieve a user group with a mobility pattern that is similar to the significant mobility pattern of the user by reference to the mobility profile 41 of user groups based on mobility to predict a destination-semantic place of a user based on the mobility pattern of the retrieved user group. The predictor 340 may retrieve a user group with characteristics that are similar to characteristics of the user by reference to the mobility profile 42 of user groups based on characteristics to predict a destination-semantic place based on the mobility pattern of the retrieved user group. The predictor 340 may predict a destination location of a user by detecting at least one significant location that corresponds to the predicted destination-semantic place by reference to the significant location profile 331. The predictor 340 will be described in detail with reference to FIG. 4.

FIG. 4 is a diagram illustrating an example of a predictor 340. Referring to FIG. 4, the predictor 340 includes a significant mobility pattern determiner 340, a user group retriever 342, a destination-semantic place predictor 343, and a destination location predictor 344. The significant mobility pattern determiner 341 performs the same function as the significant mobility pattern determiner 141 of the predictor 140. The above description of the significant mobility pattern determiner 141 of the predictor 140, is also applicable to the predictor 340, and is incorporated herein by reference. Thus, the above description may not be repeated here.

The user group retriever 342 may retrieve a user group with a mobility pattern that is similar to the significant mobility pattern of a user by reference to the mobility profile 41 of user groups based on mobility. The significant mobility pattern of the user is determined by the significant mobility pattern determiner 341. For example, the user group retriever 342 may calculate similarities between the significant mobility pattern of a user and a representative mobility profile of each user group to retrieve a user group with the highest similarity.

By reference to the mobility profile 42 of user groups based on characteristics, the user group retriever 342 may retrieve a user group with characteristics that are similar to characteristics of a user. For example, the user group retriever 342 may retrieve a user group that have the similar characteristics based on characteristic information, such as, for example, age, gender, occupation, and ethnicity of the user.

The destination-semantic place predictor 343 may predict at least one semantic place based on representative mobility profiles of each user group retrieved by the user group retriever 342.

The destination location predictor 344 may predict a destination location of a user by detecting at least one destination location that corresponds to at least one destination-semantic place predicted by the destination-semantic place predictor 343. The destination location predictor 344 may predict a destination location of a user by reference to the significant location profile 331 generated by the significant location profiler 330.

Further, if there is no profiled destination-semantic place predicted by the destination-semantic place predictor 343 upon reference to the significant location profile 331, the destination location predictor 344 may predict a destination location of a user by using other users' significant location profile information similar to the user.

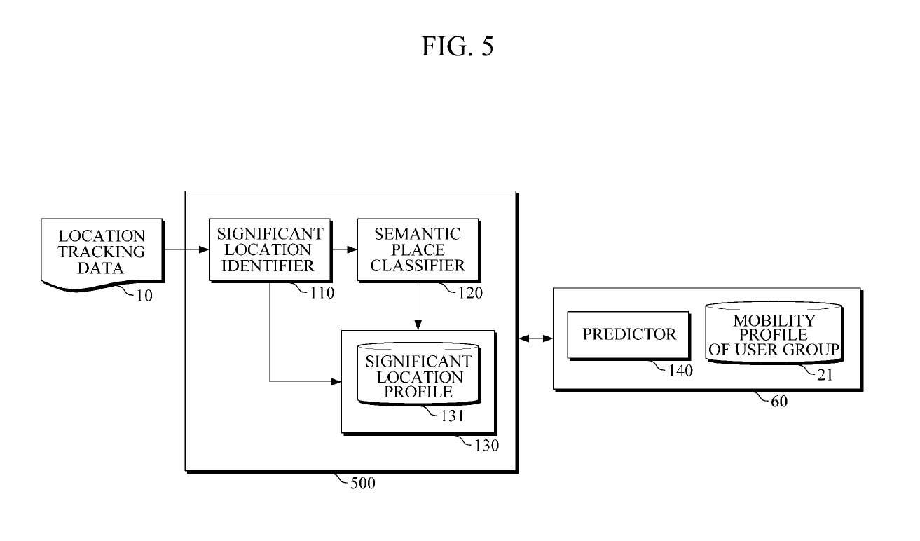

FIG. 5 is a diagram illustrating yet another example of a destination prediction apparatus. Referring to FIGS. 1 and 5, unlike the destination prediction apparatus 100, the predictor 140 of the destination prediction apparatus 500 of FIG. 5 is included in a server 60, and not in the destination prediction apparatus 500.

In this case, the destination prediction apparatus 500 may predict a destination by transmitting, to the server 60, a signal requesting destination prediction that includes semantic place tracking data generated by the semantic place classifier 120 and the significant location profile 131 generated by the significant location profiler 130. The destination prediction apparatus 500 may receive destination prediction results from the server 60.

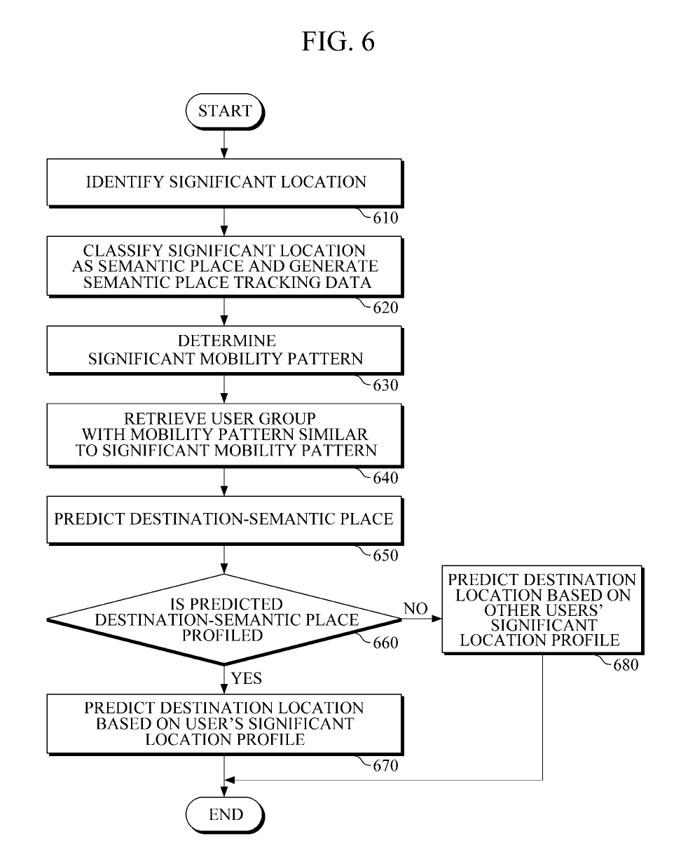

FIG. 6 is a diagram illustrating an example of a destination prediction method. The operations in FIG. 6 may be performed in the sequence and manner as shown, although the order of some operations may be changed or some of the operations omitted without departing from the spirit and scope of the illustrative examples described. Many of the operations shown in FIG. 6 may be performed in parallel or concurrently. The above descriptions of FIGS. 1-5, is also applicable to FIG. 6, and is incorporated herein by reference. Thus, the above description may not be repeated here.

Referring to FIG. 6, in 610, the destination prediction method identifies a significant location based on location tracking data of a user. For example, the significant location identifier 110 may identify, as a significant location, a location such as, for example, a location where a user stays for more than a time period, a location where a user visits for more than a number of times, a location where a user visits at a specific time cycle, and a location where a user visits at a specific time.

In 620, the identified significant location is classified as at least one significant location based on semantics to generate semantic place tracking data that corresponds to the location tracking data. For example, the semantic place classifier 120 may identify semantics of a significant location based on visit data of the significant location identified by the significant location identifier 110 and may classify the identified significant location as at least one semantic place to generate semantic place tracking data that corresponds to the location tracking data 10. The visit data may include data such as, for example, arrival/departure time, a number of visits, the duration of visits, and the time of visits.

In 630 significant mobility pattern of a user is determined based on the generated semantic place tracking data. For example, a significant mobility pattern determiner 141 may determine a significant mobility pattern of a user using methods such as, for example, a frequent item set detection algorithm, a Linear Discriminant Analysis (LDA) algorithm, and a Principal Component Analysis (PCA) algorithm.

In 640, a user group with a mobility pattern that is similar to the determined mobility pattern of a user is retrieved by reference to a mobility profile of user groups clustered according to mobility patterns.

In 650, a destination-semantic place is predicted based on a representative mobility pattern of the retrieved user group.

In 660, it is determined whether the predicted destination-semantic place is profiled, by reference to pre-stored significant location profile. If the destination-semantic place is profiled, in 670, to predict a destination location, at least one destination location corresponding to the destination-semantic place is extracted by reference to the pre-stored significant location profile.

If the destination-semantic place is not profiled, in 680, a destination location of a user is predicted using other users' significant location profile similar to the user's profile.

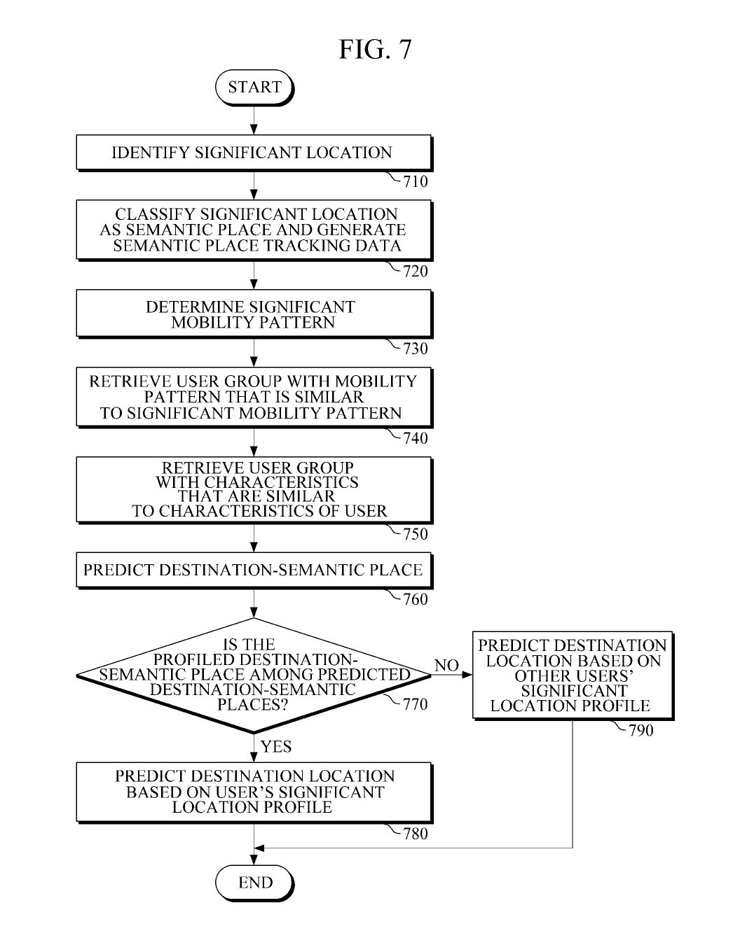

FIG. 7 is a diagram illustrating another example of a destination prediction method. The operations in FIG. 7 may be performed in the sequence and manner as shown, although the order of some operations may be changed or some of the operations omitted without departing from the spirit and scope of the illustrative examples described. Many of the operations shown in FIG. 7 may be performed in parallel or concurrently. The above descriptions of FIGS. 1-6, is also applicable to FIG. 7, and is incorporated herein by reference. Thus, the above description may not be repeated here.

Referring to FIG. 7, in 710 the destination prediction method includes identifying a significant location based on location detection data of a user.

In 720, the identified significant location is classified as at least one significant semantic place based on semantics to generate semantic place detection data that corresponds to the location detection data.

In 730, a significant mobility pattern of a user is determined based on the generated semantic place detection data.

In 740, a user group with a mobility pattern that is similar to the determined significant mobility pattern of a user is retrieved by reference to a mobility profile of user groups clustered according to mobility patterns.

In 750, a user group with characteristics that are similar to characteristics of a user is retrieved by reference to the mobility profile of user groups clustered according to user characteristics.

in 760, at least one destination-semantic place is predicted based on a representative mobility pattern of each of the retrieved user groups.

In 770, it is determined by reference to a pre-stored significant location profile, whether there is a profiled destination-semantic place among the at least one predicted destination-semantic place. If there is a profiled destination-semantic place, in 780, at least one destination location corresponding to the destination-semantic place is extracted by reference to the pre-stored significant location profile to predict a destination location.

If there is no profiled destination-semantic place, in 790, a destination location of a user is predicted using other users' significant location profile similar to the user's profile.

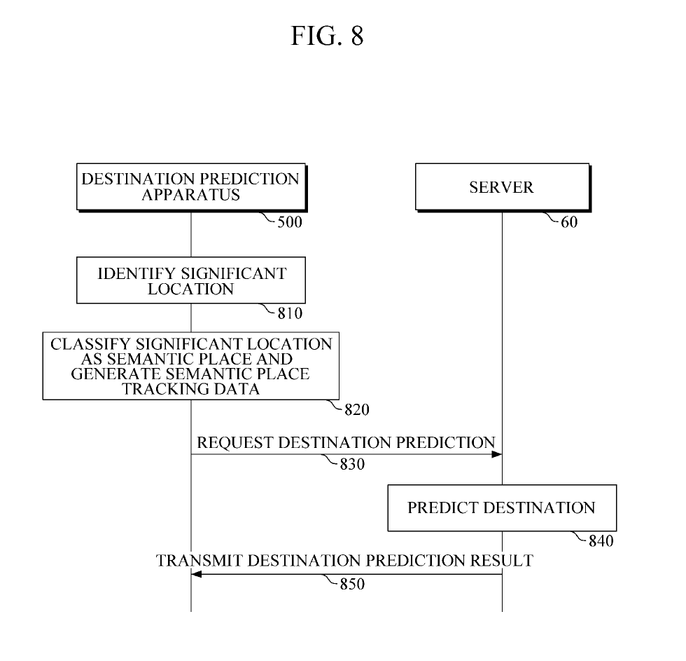

FIG. 8 is a diagram illustrating another example of a destination prediction method. The operations in FIG. 8 may be performed in the sequence and manner as shown, although the order of some operations may be changed or some of the operations omitted without departing from the spirit and scope of the illustrative examples described. Many of the operations shown in FIG. 8 may be performed in parallel or concurrently. The above descriptions of FIGS. 1-7, is also applicable to FIG. 8, and is incorporated herein by reference. Thus, the above description may not be repeated here.

Referring to FIG. 8, in 810, the destination prediction apparatus 500 first identifies a significant location based on location detection data of a user.

In 820, the destination prediction apparatus 500 classifies the identified significant location as at least one semantic place based on semantics and generates semantic place detection data that corresponds to the location detection data.

In 830, the destination prediction apparatus 500 transmits, to the server 60, a signal requesting destination prediction that includes semantic place detection data and a pre-stored significant location profile.

In 840, upon receiving the signal for requesting destination prediction, the server 60 predicts a destination based on the received semantic place detection data, the significant location profile, and the mobility profile 21 of user groups clustered according to mobility patterns.

In 850, the server 60 transmits destination prediction results to the destination prediction apparatus 500.

As described above, a location-based proactive information provisioning service may be provided without a down time from the start of the service. By predicting a next destination of a user, various information may be efficiently provided to a user.

The apparatuses, units, modules, devices, and other components illustrated in FIGS. 1-5 that perform the operations described herein with respect to FIGS. 1-5 are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 1-5. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 6-8 that perform the operations described herein with respect to FIGS. 6-8 are performed by a processor or a computer as described above executing instructions or software to perform the operations described herein.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any device known to one of ordinary skill in the art that is capable of storing the instructions or software and any associated data, data files, and data structures in a non-transitory manner and providing the instructions or software and any associated data, data files, and data structures to a processor or computer so that the processor or computer can execute the instructions. In one example, the instructions or software and any associated data, data files, and data structures are distributed over network-coupled computer systems so that the instructions and software and any associated data, data files, and data structures are stored, accessed, and executed in a distributed fashion by the processor or computer.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A destination prediction apparatus comprising:
a significant location identifier configured to identify a significant location based on tracking data of a user;
a semantic place classifier configured to generate semantic place tracking data by classifying the identified significant location as a semantic place based on semantics;
a significant location profiler configured to profile visit data of significant locations of each of the semantic places to generate a significant location profile; and
a predictor configured to predict a destination of the user based on the generated semantic place tracking data, the generated significant location profile, and a mobility profile of user groups clustered according to mobility patterns.

2. The apparatus of claim 1, wherein the significant location comprises at least one of a location where the user stays for more than a time period, a location where the user visits for more than a number of times, a location where the user visits during a time cycle, or a location that the user visits at a particular time.

3. The apparatus of claim 1, wherein the mobility profile of user groups clustered according to the mobility patterns is pre-defined in a server.

4. The apparatus of claim 1, wherein the predictor comprises:
a significant mobility pattern determiner configured to determine a significant mobility pattern of the user based on the generated semantic place tracking data;
a user group retriever configured to retrieve a user group having a mobility pattern similar to the determined significant mobility pattern;
a destination-semantic place predictor configured to predict a destination-semantic place based on the mobility pattern of the retrieved user group; and
a destination location predictor configured to extract at least one destination location that corresponds to the predicted destination-semantic place and the generated significant location profile.

5. The apparatus of claim 4, wherein in response to the predicted destination-semantic place not being profiled upon reference to the generated significant location profile, the destination location predictor is further configured to predict a destination location of the user using other users' significant location profile information that is similar to the profile of the user.

6. The apparatus of claim 1, wherein the predictor is further configured to predict a destination based on the generated semantic place tracking data, the generated significant location profile, the mobility profile of user groups clustered according to mobility patterns, and a mobility profile of user groups clustered according to user characteristics.

7. The apparatus of claim 6, wherein the mobility profile of user groups clustered according to mobility patterns and the mobility profile of user groups clustered according to user characteristics are pre-defined in a server.

8. The apparatus of claim 6, wherein the predictor comprises:
a significant mobility pattern determiner configured to determine a significant mobility pattern of the user based on the generated semantic place tracking data;
a user group retriever configured to retrieve a first user group having a mobility pattern similar to the determined significant mobility pattern by reference to the mobility profile of the user groups clustered according to the mobility patterns, and to retrieve a second user group having characteristics similar to characteristics of the user by reference to the mobility profile of the user groups clustered according to user characteristics;
a destination-semantic place predictor configured to predict at least one destination-semantic place based on the mobility patterns of the first user group and the mobility patterns of the second user group; and
a destination location predictor configured to extract at least one destination location that corresponds to the at least one predicted destination and the generated significant location profile.

9. The apparatus of claim 8, wherein in response to the at least one predicted destination-semantic place not being among the significant location profile, the destination location predictor is further configured to predict a destination location of the user using other users' significant location profile information that is similar to the profile of the user.

10. The apparatus of claim 1, wherein the visit data comprises at least one of arrival time, departure time, a number of visits, a duration of visits, or a time of visit.

11. The apparatus of claim 3, wherein the server is external.

12. A destination prediction method comprising:
recognizing a significant location based on tracking data of a user;
generating semantic place tracking data based on classifying the significant location as a semantic place based on semantics; and
predicting a destination of the user based on the generated semantic place tracking data, a pre-defined significant location profile of the user, and a mobility profile of user groups clustered according to mobility patterns.

13. The method of claim 12, wherein the recognizing of the significant location comprises recognizing at least one of a location where the user stays for more than a time period, a location where the user visits for more than a number of times, a location where the user visits during a time cycle, or a location that the user visits at a particular time as the significant location.

14. The method of claim 12, wherein the predicting of the destination of the user comprises:
determining a significant mobility pattern of the user based on the generated semantic place tracking data;
retrieving a user group having a mobility pattern that is similar to the determined significant mobility pattern;
predicting a destination-semantic place based on the mobility pattern of the retrieved user group; and
extracting at least one destination location that corresponds to the predicted destination-semantic place and the pre-defined significant location profile.

15. The method of claim 14, further comprising predicting a destination location of the user using other users' significant location profile information that is similar to the profile of the user, in response to the predicted destination-semantic place not being profiled upon reference to the significant location profile.

16. The method of claim 12, wherein the predicting of the destination of the user comprises predicting the destination based on the generated semantic place tracking data, the significant location profile, the mobility profile of user groups clustered according to mobility patterns, and a mobility profile of user groups clustered according to user characteristics.

17. The method of claim 12, wherein the predicting of the destination of the user comprises:
determining a significant mobility pattern of the user based on the generated semantic place tracking data;
retrieving a first user group having a mobility pattern similar to the determined significant mobility pattern by reference to the mobility profile of the user groups clustered according to the mobility patterns, and retrieving a second user group having characteristics similar to characteristics of the user by reference to the mobility profile of the user groups clustered according to the user characteristics;
predicting at least one destination-semantic place based on the mobility patterns of the first user group and the mobility patterns of the second user group; and
extracting at least one destination location that corresponds to the at least one predicted destination-semantic place and the pre-defined significant location profile.

18. The method of claim 17, further comprising, in response to the at least one predicted destination-semantic place not being among the pre-defined significant location profile, predicting a destination location of the user by using other users' significant location profile information that is similar to the profile of the user.

19. A destination prediction method comprising:
identifying a significant location based on tracking data of a user;
generating semantic place tracking data based on classifying the significant location;
building a significant location profile based on the identified significant location;
determining a significant mobility pattern of the user based on the semantic place tracking data; and
predicting a destination of the user based on the significant mobility pattern of the user and the significant location profile.

20. The method of claim 19, wherein the predicting of the destination of the user comprises:
retrieving, at the server, a user group having a mobility pattern similar to the significant mobility pattern;
predicting a destination-semantic place based on the mobility pattern of the retrieved user group; and
extracting at least one destination location that corresponds to the predicted destination-semantic place and the significant location profile.

21. The method of claim 19, wherein the predicting of the destination of the user comprises:
retrieving, at the server, a first user group having a mobility pattern similar to the significant mobility pattern by reference to the mobility profile of the user groups clustered according to the mobility patterns, and retrieving a second user group having characteristics similar to characteristics of the user by reference to the mobility profile of the user groups clustered according to the user characteristics;
predicting a destination-semantic place based on the mobility patterns of the first user group and the mobility patterns of the second user group; and
extracting at least one destination location that corresponds to the predicted destination-semantic place and the significant location profile.
